(19) United States
(12) Patent Application Publication
(10) Pub. No.: US 2013/0271667 A1
(43) Pub. Date: Oct. 17, 2013

(54) VIDEO PROCESSING APPARATUS AND VIDEO PROCESSING METHOD

(71) Applicant: CANON KABUSHIKI KAISHA, TOKYO (JP)

(72) Inventor: Hiroshi Tojo, Fuchu-shi (JP)

(73) Assignee: CANON KABUSHIKI KAISHA, TOKYO (JP)

(21) Appl. No.: 13/856,887

(22) Filed: Apr. 4, 2013

(30) Foreign Application Priority Data
Apr. 11, 2012 (JP) 2012-090449

(51) Int. Cl. H04N 5/14

(52) U.S. Cl. CPC H04N 5/147
USPC 348/701

(57) ABSTRACT

An input video is compared with a background model. Based on the comparison result, a duration time during which a difference region different from the background model continues in the input video is measured. The difference region whose duration time is less than a predetermined threshold is determined as a foreground. A scene change in the input video is detected based on the comparison result. Upon detecting the scene change, the predetermined threshold is changed.

### BACKGROUND OF THE INVENTION

1. Field of the Invention

The present invention relates to an object detection technique.

2. Description of the Related Art

A background subtraction method is disclosed as a technique of detecting an object from in image sensed by a camera. In the background subtraction method, an image of background without an object is sensed in advance using a fixed camera, and the feature amount is stored as a background model. After that, the difference between the feature amount in the background model and the feature amount in an image input from the camera is obtained, and a region with the different feature amount is detected as the foreground (object).

A stationary object for example, a bag or flower vase that has newly appeared will be considered. An object such as a bag may have been abandoned by a person and is therefore a target to be detected for a while after the appearance. However, an object (for example, a flower vase) that exists for a long time can be regarded as part of the background and is therefore to be handled more as part of the background.

In U.S. Publication No. 2009/0290020 (patent literature 1), an object is detected using not only the image feature amount difference but also a condition concerning the duration time representing how long an image feature amount has continuously existed in a video as the foreground/background determination condition. To enable this, not only the feature amount of the background but also the feature amount of a detected object is held as the background model. For example, when a red bag is placed, a red feature amount is added. If the red bag is abandoned, the duration time is prolonged because the red feature amount is considered to be always continuously present at the same position in the video. Hence, determining based on the duration time whether an object is the foreground or background makes it possible to detect it as an object before the elapse of a desired time and handle it as the background after that.

On the other hand, for example, if illumination in a room is turned off, the whole frame image darkens uniformly. Since a large image feature amount difference is generated, the entire screen is erroneously detected as an object. In this case, in the method of patent literature 1, the entire screen is handled as an object until the predetermined time has elapsed. Hence, even if a true object (person) appears in the screen during this time, the region cannot correctly be detected. This also applies to a case in which the entire image is uniformly brightened by turning on the illumination.

There is disclosed a method of avoiding a detection error caused by a short-time video change (scene change) in the entire screen at the time of illumination on/off or a change in the camera direction. In U.S. Publication No. 2006/0045335 (patent literature 2), a background model is created in advance for each of a scene with the illumination on and a scene with the illumination off. When the proportion of a detected object region in the screen is high, the background model currently in use is determined to be inappropriate and switched to another background model. With this mechanism, the background models created in the illumination on and off states are selectively used, thereby avoiding a detection error in the entire screen.

In Japanese Patent Laid-Open No. 2000-324477 (patent literature 3), when the proportion of an object region in the screen is high, the current background model is replaced with the input image. That is, the background model is recreated, thereby avoiding a detection error in the entire screen.

In the method of patent literature 2, however, a problem arises in the following case. For example, when a change has occurred in the background during illumination on due to placement of a flower vase or the like, the change is not reflected on the background model generated in the illumination off state, and a difference is generated. That is, when the illumination is turned off for the next time, the background model without the flower vase is compared with the input image with the flower vase. For this reason, the flower vase that has temporarily existed as the background is detected newly. In this case, the abandoned object cannot correctly be detected.

In the method of patent literature 3, a problem arises in the following case. For example, if a bag is placed during illumination on, and the illumination is temporarily turned off and then turned on again, the background model is exchanged every time the illumination is turned on/off. For this reason, the bag detected before the illumination is turned off is included in the background when the illumination is turned on again, and cannot be detected as an object. That is, when the illumination is temporarily turned off, the abandoned object cannot be detected.

As described above, the related arts cannot implement both avoiding a detection error caused by a scene change and temporary detecting a stationary object (detecting an abandoned object).

### SUMMARY OF THE INVENTION

The present invention has been made in consideration of the above-described problems, and provides a technique of enabling to avoid a detection error state of an entire screen even in case of a scene change caused by turning on/off illumination and temporarily detect a stationary object and then handle it as the background.

According to the first aspect of the present invention, there is provided a video processing apparatus comprising: a comparison unit configured to compare an input video with a background model; a timer unit configured to measure, based on a comparison result of the comparison unit, a duration time during which a difference region different from the background model continues in the input video; a determination unit configured to determine the difference region whose duration time is less than a predetermined threshold as a foreground; a detection unit configured to detect a scene change in the input video based on the comparison result of the comparison unit; and a changing unit configured to change the predetermined threshold when the detection unit has detected the scene change.

According to the second aspect of the present invention, there is provided a video processing method comprising: a comparison step of comparing an input video with a background model; a timer step of measuring, based on a comparison result in the comparison step, a duration time during which a difference region different from the background model continues in the input video; a determination step of determining the difference region whose duration time is less than a predetermined threshold as a foreground; a detection step of detecting a scene change in the input video based on the comparison result in the comparison step; and a changing step of changing the predetermined threshold when the scene change has been detected in the detection step.

Further features of the present invention will become apparent from the following description of exemplary embodiments with reference to the attached drawings.

### BRIEF DESCRIPTION OF THE DRAWINGS

FIG. 1 is a block diagram showing an example of the arrangement of a computer;

FIG. 2 is a block diagram showing an example of the functional arrangement of an image processing apparatus;

FIG. 3 is a flowchart of processing performed by the image processing apparatus;

FIG. 4 is a flowchart showing details of processing in step S302;

FIG. 5 is a view showing an example of the structure of a background model;

FIG. 6 is a flowchart of processing in step S303;

FIG. 7 is a view showing an example of the structure of comparison result information;

FIG. 8 is a flowchart showing details of processing in step S304;

FIG. 9 is a view showing an example of the structure of foreground/background information;

FIG. 10 is a flowchart showing details of processes in steps S305 and S306;

FIG. 11 is a graph of a duration time;

FIG. 12 is a graph of a duration time;

FIG. 13 is a view showing examples of frame images;

FIG. 14 is a graph of a duration time;

FIG. 15 is a view showing examples of frame images;

FIG. 16 is a graph of a duration time;

FIG. 17 is a graph of a duration time;

FIG. 18 is a flowchart showing details of processing in step S307; and

FIG. 19 is a view showing an example of the structure of object region information.

### DESCRIPTION OF THE EMBODIMENTS

The embodiments of the present invention will now be described with reference to the accompanying drawings. Note that the embodiments to be described below are examples of detailed implementation of the present invention or detailed examples of the arrangement described in the appended claims.

### First Embodiment

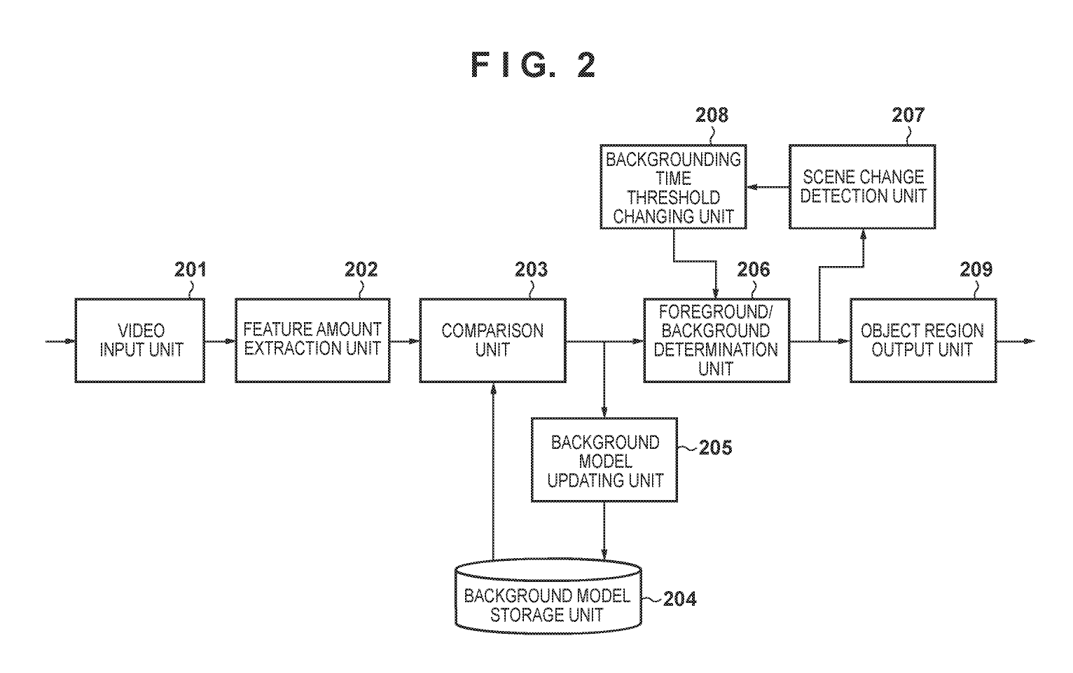

An example of the functional arrangement of an image processing apparatus according to this embodiment will be described first with reference to the block diagram of FIG. 2. In this embodiment, an image processing apparatus having the functional arrangement shown in FIG. 2 is used. However, the arrangement shown in FIG. 2 can be modified or changed as needed. The arrangement applicable to the embodiment is not limited to that shown in FIG. 2.

A video input unit 201 inputs the image of each frame as a frame image, and sends the input frame image to a feature amount extraction unit 202 at the subsequent stage. The frame image acquisition source is not limited to a specific acquisition source. The frame image of each frame may sequentially be read out from a movie stored in an appropriate memory, or the frame image of each frame sequentially sent from an image sensing device capable of sensing a movie may be acquired. The feature amount extraction unit 202 acquires the image feature amount of each of rectangle regions included in the frame image received from the video input unit 201.

A comparison unit 203 compares the image feature amount acquired by the feature amount extraction unit 202 for each rectangle region with a background model stored in a background model storage unit 204. The background model storage unit 204 holds the background model in which the state of each rectangle region in the frame image is represented by the image feature amount.

A background model updating unit 205 updates the background model in the background model storage unit 204 in accordance with the comparison result of the comparison unit 203. A foreground/background determination unit 206 determines based on the comparison result of the comparison unit 203 whether each rectangle region included in the frame image is a foreground rectangle region that is a rectangle region constituting the foreground or a background rectangle region that is a rectangle region constituting the background.

A scene change detection unit 207 detects the presence/absence of a scene change. A backgrounding time threshold changing unit 208 controls a threshold to be used by the foreground/background determination unit 206 to perform the above-described determination in accordance with the detection result of the scene change detection unit 207. An object region output unit 209 outputs object region information including region information representing the region of an object included in the frame image and the length of the period during which the object is included.

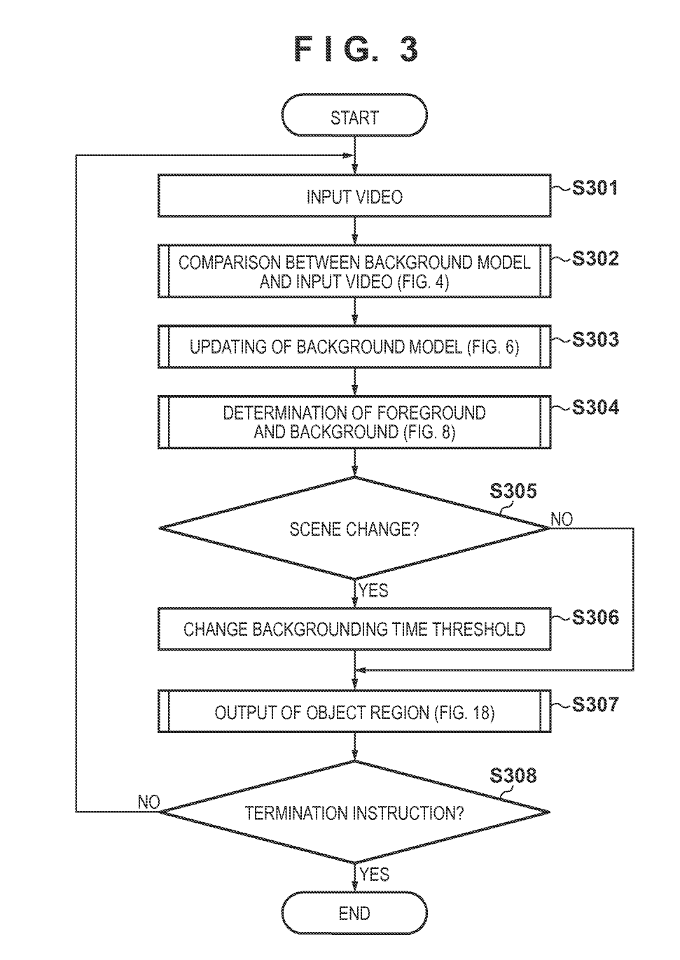

Processing performed by the image processing apparatus according to this embodiment will be described next with reference to FIG. 3 that shows the flowchart of the processing. In step S301, the video input unit 201 acquires a frame image f of one frame and send the acquired frame image f to the feature amount extraction unit 202 at the subsequent stage.

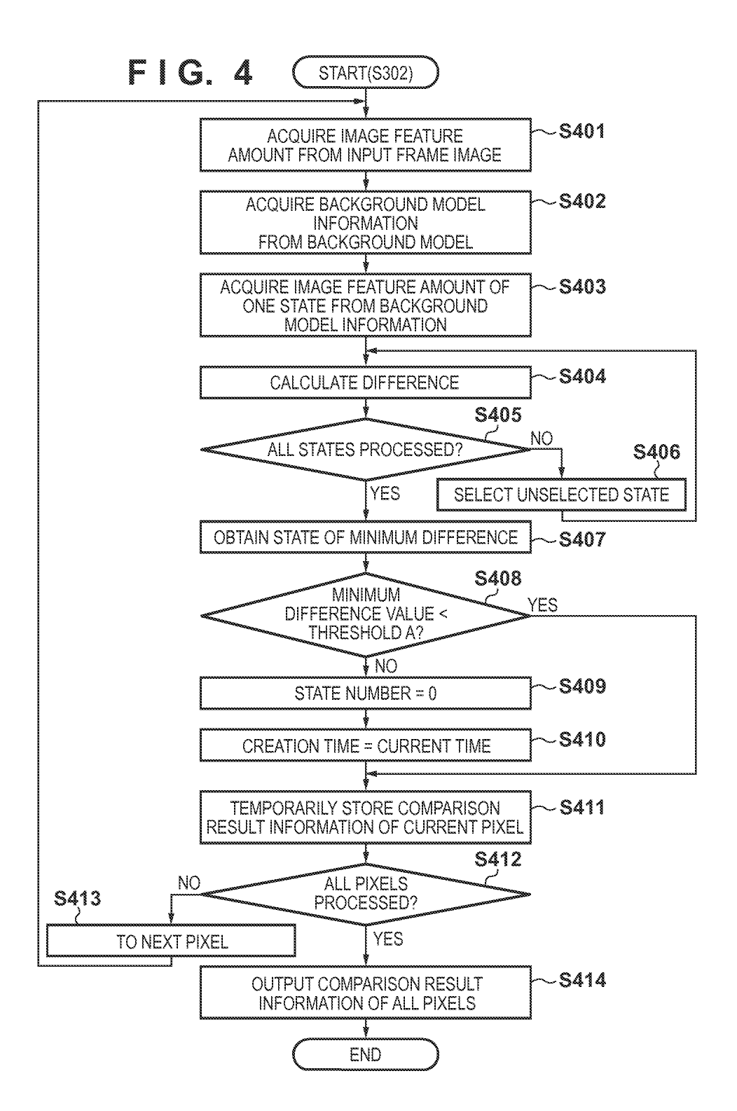

In step S302, the feature amount extraction unit 202 acquires the image feature amount of each rectangle region included in the frame image f received from the video input unit 201. The comparison unit 203 compares the image feature amount acquired by the feature amount extraction unit 202 for each rectangle region with a background model stored in the background model storage unit 204. Details of processing in step S302 will be described with reference to the flowchart of FIG. 4.

In step S401, the feature amount extraction unit 202 acquires the image feature amount of a rectangle region in the frame image f received from the video input unit 201. When performing the processing in step S401 for the first time, the image feature amount of a rectangle region located at the upper left corner of the frame image f is acquired. In step S401 of the second time, the image feature amount of an immediately adjacent rectangle region on the right side is acquired. In this way, the rectangle regions included in the frame image f are referred to in the raster scan order from the upper left corner to the lower right corner, thereby acquiring the image feature amounts of the referred rectangle regions. Note that the reference may be done in an order other than the raster scan order.

In this embodiment, the rectangle region is a rectangle region corresponding to one pixel, and the image feature amount is the pixel value (luminance value). Hence, in this embodiment, the pixel value of a pixel located at a pixel position (x, y) in the frame image f is acquired in step S401 (0≦x≦(number of x-direction pixels of frame image f−1), 0≦y≦(number of y-direction pixels of frame image f−1).

When performing the processing in step S401 for the first time, the pixel value of a pixel located at a pixel position (0, 0) of the upper left corner of the frame image f is acquired. In step S401 of the second time, the pixel value of a pixel located at an immediately adjacent pixel position (x+1, y) on the right side is acquired. In this way, the pixels included in the frame image f are referred to in the raster scan order from the upper left corner to the lower right corner, thereby acquiring the pixel values of the referred pixels. As described above, the reference may be done in an order other than the raster scan order.

If the rectangle region is a rectangle pixel block formed from a plurality of pixels (for example, 8×8 pixels), the image feature amount may be the average value of the pixel values of the pixels included in the rectangle pixel block. A DCT coefficient may be used as the image feature amount. The DCT coefficient is the result of DCT (Discrete Cosine Transform) of an image. Hence, if the frame image has been compression-coded by JPEG, the feature amount has already been extracted as the DCT coefficient at the time of image compression. In this case, the DCT coefficient may directly be extracted from the frame image of JPEG format and used as the image feature amount. In this embodiment, starting from the pixel position at the upper left corner of the frame image, the subsequent processing is performed while moving the pixel position from left to right and downward in each row (in the raster scan order). In step S402, the comparison unit 203 reads out background model information corresponding to the pixel position (x, y) from the background model stored in the background model storage unit 204.

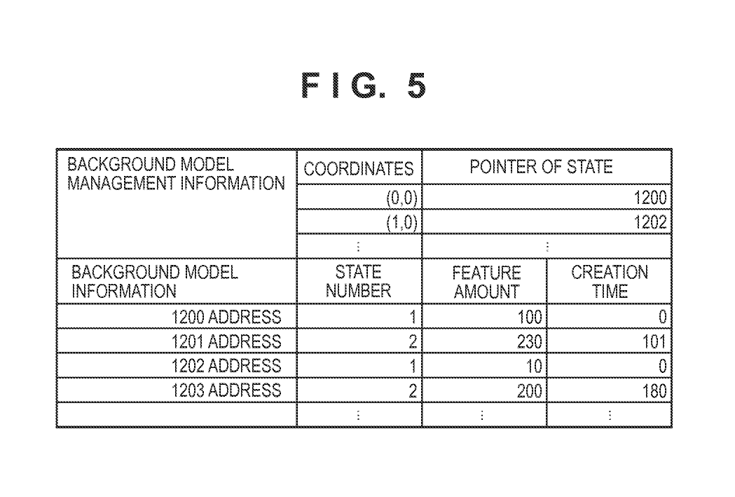

An example of the structure of the background model will be explained here with reference to FIG. 5. As shown in FIG. 5, the background model includes background model management information and background model information. The background model management information is table information that registers a pointer to the background model information in correspondence with each pixel position (coordinates) in the frame image. Note that when the rectangle region is a rectangle pixel block, the background model management information is table information that registers a pointer to the background model information in correspondence with each rectangle pixel block in the frame image.

The background model information includes a state number, an image feature amount, and a creation time.

The state number is used to identify an image feature amount (in this embodiment, a pixel value) registered for one pixel. The same state number is issued for the same image feature amount, and different state numbers are issued for different image feature amounts. For example, when a red car comes to a stop in front of a blue wall, two states, that is, the state of a blue feature amount and the state of a red feature amount are held for each pixels included in a region where the red car rests.

In FIG. 5, the state number issued first is “1”. For this reason, the state number “1” is issued for the image feature amount “100” registered for the pixel position (0, 0) for the first time. The frame number (creation time) of the frame image of the acquisition source of the image feature amount “100” is “0”. The state number “1”, the image feature amount “100”, and the creation time “0” are stored at an address 1200 as a set. Note that the creation time may be the time at which the pieces of information (or the image feature amount) are registered in the background model.

In FIG. 5, the pointer to the address 1200 is associated with the pixel position (0, 0), and the pointer to an address 1202 is associated with the pixel position (1, 0). In this case, pieces of background model information registered at the addresses 1200 and 1201 are associated with the pixel position (0, 0). That is, pieces of background model information corresponding to one pixel position are registered at consecutive addresses.

Hence, in step S402, the following processing is performed. That is, pieces of background model information corresponding to the respective addresses from an address indicated by a pointer corresponding to the pixel position (x, y) to an address obtained by subtracting 1 from an address indicated by a pointer corresponding to the pixel position registered in the row immediately under the pixel position (x, y) are read out.

Note that “the pixel position registered in the row immediately under the pixel position (x, y)” is an expression limited to the background model structure shown in FIG. 5, and this expression will be used below. However, when the pointers corresponding to the pixel positions are managed in the order of pixel positions A1, A2, A3, . . . , “the pixel position registered in the row immediately under the pixel position A1” corresponds to the pixel position A2. Hence, the expression is interpreted in accordance with the pixel position management order.

In step S403, the comparison unit 203 selects one of the pieces of background model information read out in step S402 as selected background model information. The comparison unit 203 acquires the pixel value in the selected background model information.

In step S404, the comparison unit 203 obtains the difference between the pixel value acquired in step S401 and the pixel value acquired in step S403. Various methods can be considered as the method of obtaining the difference, and the present invention is not limited to using a specific method. For example, the absolute value of the difference between the pixel values may simply be obtained as the difference. Alternatively, the square of the difference between the pixel values may be obtained as the difference. The comparison unit 203 temporarily holds the obtained difference in association with the selected background model information selected in step S403.

In step S405, the comparison unit 203 determines whether all pieces of background model information read out in step S402 have been selected as the selected background model information. Upon determining that all pieces of background model information have been selected, the process advances to step S407. If unselected background model information remains, the process advances to step S406.

In step S406, the comparison unit 203 selects one of the pieces of unselected background model information as new selected background model information, and the process advances to step S404. In step S407, the comparison unit 203 identifies the minimum difference out of the differences obtained in step S404.

In step S408, the comparison unit 203 compares the minimum difference identified in step S407 with a preset threshold A. If the minimum difference identified in step S407 is smaller than the threshold A as the comparison result, the process advances to step S411. If the minimum difference specified in step S407 is equal to or larger than the threshold A, the process advances to step S409.

In step S409, the comparison unit 203 issues a state number 0. Note that the state number to be issued is not limited to 0 and can be an appropriate numerical value. However, the value needs to prevent confusion with the state numbers corresponding to the respective states, as shown in FIG. 5.

In step S410, the comparison unit 203 acquires the frame number of the frame image f as the creation time. The current time measured by the timer in the image processing apparatus may be acquired as the creation time, as a matter of course.

When the process advances from step S410 to step S411, the comparison unit 203 performs the following processing in step S411. That is, the comparison unit 203 stores the set of the state number 0 issued in step S409, the frame number acquired in step S410, and the pixel value of the pixel at the pixel position (x, y) acquired in step S401 in an appropriate memory of the image processing apparatus.

On the other hand, when the process advances from step S408 to step S411, the comparison unit 203 performs the following processing in step S411. That is, the comparison unit 203 stores the selected background model information held in step S404 in association with the minimum difference identified in step S407, that is, the set of the state number, the pixel value, and the frame number included in the selected background model information in the appropriate memory of the image processing apparatus.

In step S412, the comparison unit 203 determines whether the processes of steps S401 to S411 have been done for all pixels included in the frame image f. Upon determining that the processes have been done for all pixels, the process advances to step S414. If a pixel that has not undergone the processes of steps S401 to S411 yet remains, the process advances to step S413. In step S413, the comparison unit 203 moves the pixel position to be referred to by one and performs the processes from step S401 for the pixel position after the movement.

At the point of time the process has advanced to step S414, a table in which a set of a state number, a pixel value, and a creation time is registered in correspondence with each pixel position of the frame image f has been created in the memory of the image processing apparatus, as shown in FIG. 7. In step S414, the comparison unit 203 sends this table to the background model updating unit 205 and the foreground/background determination unit 206 as comparison result information of the comparison unit 203.

Note that at the time of start of the operation of the image processing apparatus, no background model information is stored in the background model storage unit 204. In this case, as the difference value, for example, the maximum value the value can take is set. The set of the state number 0, the frame number of the frame image f, and the pixel value of the pixel at the pixel position (x, y) of the frame image f is thus registered. In this way, the background model can be initialized by the frame image at the time of activation.

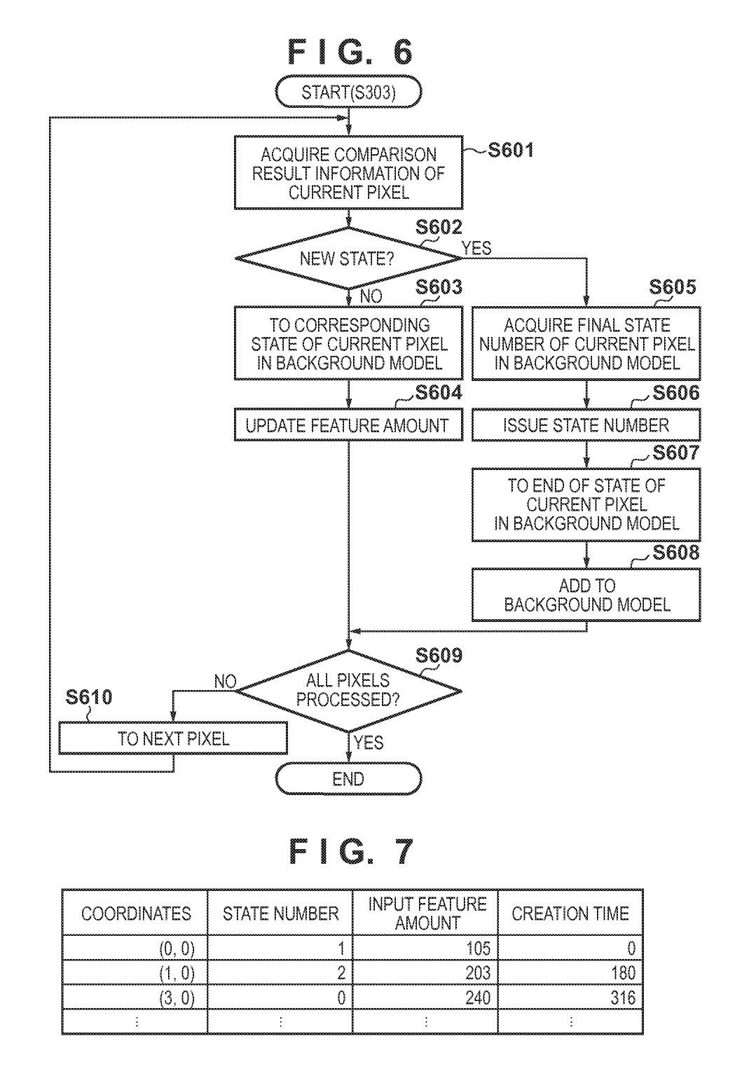

Next, in step S303, the background model updating unit 205 updates the background model in the background model storage unit 204 using the comparison result information (FIG. 7) received from the comparison unit 203. Details of processing in step S303 will be described with reference to the flowchart of FIG. 6.

In step S601, the background model updating unit 205 reads out the state number corresponding to the pixel position (x, y) in the comparison result information sent from the comparison unit 203 (0≦x≦(number of x-direction pixels of frame image f−1), 0≦y≦(number of y-direction pixels of frame image f−1). Note that when performing the processing in step S601 for the first time, x=y=0.

In step S602, the background model updating unit 205 determines whether the state number read out in step S601 is 0. Upon determining that the state number read out in step S601 is 0, the process advances to step S605. If the state number is not 0, the process advances to step S603.

If a state number k other than 0 has been issued in step S409, the background model updating unit 205 determines in step S602 whether the state number read out in step S601 is k.

In step S603, the background model updating unit 205 specifies the pointer corresponding to the pixel position (x, y) by referring to the background model management information. Background model information corresponding to the state number read out in step S601 is specified out of pieces of background model information corresponding to the respective addresses from the address indicated by the pointer to “an address indicated by a pointer corresponding to a pixel position registered in the row immediately under the pixel position (x, y)−1”.

In step S604, the background model updating unit 205 updates the pixel value in the background model information specified in step S603. To cope with a change caused by an illumination change or the like, this updating is done using

μₜ=(1−α)×μₜ₋₁+α×Iₜ

where t is the frame number of the frame image f, μₜ₋₁ is the pixel value in the background model information specified in step S603, and Iₜ is the pixel value of the pixel value at the pixel position (x, y) of the frame image f. In addition, μₜ is the pixel value after the pixel value in the background model information specified in step S603 has been updated, and α is a real number that is preset and satisfies 0≦α≦1.

On the other hand, in step S605, the background model updating unit 205 refers to the background model management information and acquires the state number in the background model information corresponding to an address obtained by subtracting 1 from an address indicated by a pointer corresponding to a pixel position registered in the row immediately under the pixel position (x, y).

In step S606, the background model updating unit 205 issues a state number obtained by adding 1 to the state number acquired in step S605. Note that 1 is assigned when a state is added to the background model for the first time as in activating the image processing apparatus.

In step S607, the background model updating unit 205 refers to the background model management information and moves background model information stored at an address indicated by a pointer registered in each of the rows under the pixel position (x, y) to an address obtained by adding 1 to the address. In addition, the background model updating unit 205 refers to the background model management information and adds 1 to the address indicated by the pointer registered in each of the rows under the pixel position (x, y).

In step S608, the background model updating unit 205 registers the following set at the address obtained by subtracting 1 from the address indicated by the pointer corresponding to the pixel position registered in the row immediately under the pixel position (x, y). That is, the set of the state number issued in step S606, the pixel value corresponding to the pixel position (x, y) in the comparison result information, and the creation time is registered.

In step S609, the background model updating unit 205 determines whether the processes of steps S601 to S608 have been done for all pixel positions. Upon determining that the processes of steps S601 to S608 have been done for all pixel positions, the process advances to step S304. If a pixel position that has not undergone the processes of steps S601 to S608 yet remains, the process advances to step S610.

In step S610, the background model updating unit 205 moves the pixel position to be referred to by one and performs the processes from step S601 for the pixel position after the movement.

In step S304, the foreground/background determination unit 206 determines whether each pixel included in the frame image f is a pixel constituting the foreground or a pixel constituting the background. Details of processing in step S304 will be described with reference to the flowchart of FIG. 8.

In step S801, the foreground/background determination unit 206 reads out the creation time corresponding to the pixel position (x, y) in the comparison result information sent from the comparison unit 203 (0≦x≦(number of x-direction pixels of frame image f−1), 0≦y≦(number of y-direction pixels of frame image f−1). Note that when performing the processing in step S801 for the first time, x=y=0.

In step S802, the foreground/background determination unit 206 calculates the difference between the creation time read out in step S801 and the current time (the frame number of the frame image f) acquired in step S410 as a duration time (time of continuous existence). The difference to be calculated may be obtained by any other method as long as it represents a duration time (current time−creation time) from the time at which a certain state (feature) has appeared in the video to the current time.

In step S803, the foreground/background determination unit 206 compares the difference obtained in step S802 with a threshold B (backgrounding time threshold). If the threshold B is, for example, 5 min (9,000 frames at 30 frame per sec), it is possible to detect (a stationary object) as an object (foreground) for 5 min.

If the difference obtained in step S802 is larger than the threshold B as the comparison result, the process advances to step S804. If the difference obtained in step S802 is equal to or smaller than the threshold B, the process advances to step S805.

In step S804, the foreground/background determination unit 206 sets the foreground flag to 0. On the other hand, in step S805, the foreground/background determination unit 206 sets the foreground flag to 1. Note that any other value may be employed as the value of the foreground flag as long as it allows discriminating between the foreground and the background.

In step S806, the foreground/background determination unit 206 stores the set of the pixel position (x, y), the duration time obtained in step S802, and the value of the foreground flag in the appropriate memory of the image processing apparatus.

In step S807, the foreground/background determination unit 206 determines whether the processes of steps S801 to S806 have been done for all pixels included in the frame image f. Upon determining that the processes of steps S801 to S806 have been done for all pixels included in the frame image f, the process advances to step S809. If a pixel that has not undergone the processes of steps S801 to S806 yet remains, the process advances to step S808.

In step S808, the foreground/background determination unit 206 moves the pixel position to be referred to by one and performs the processes from step S801 for the pixel position after the movement.

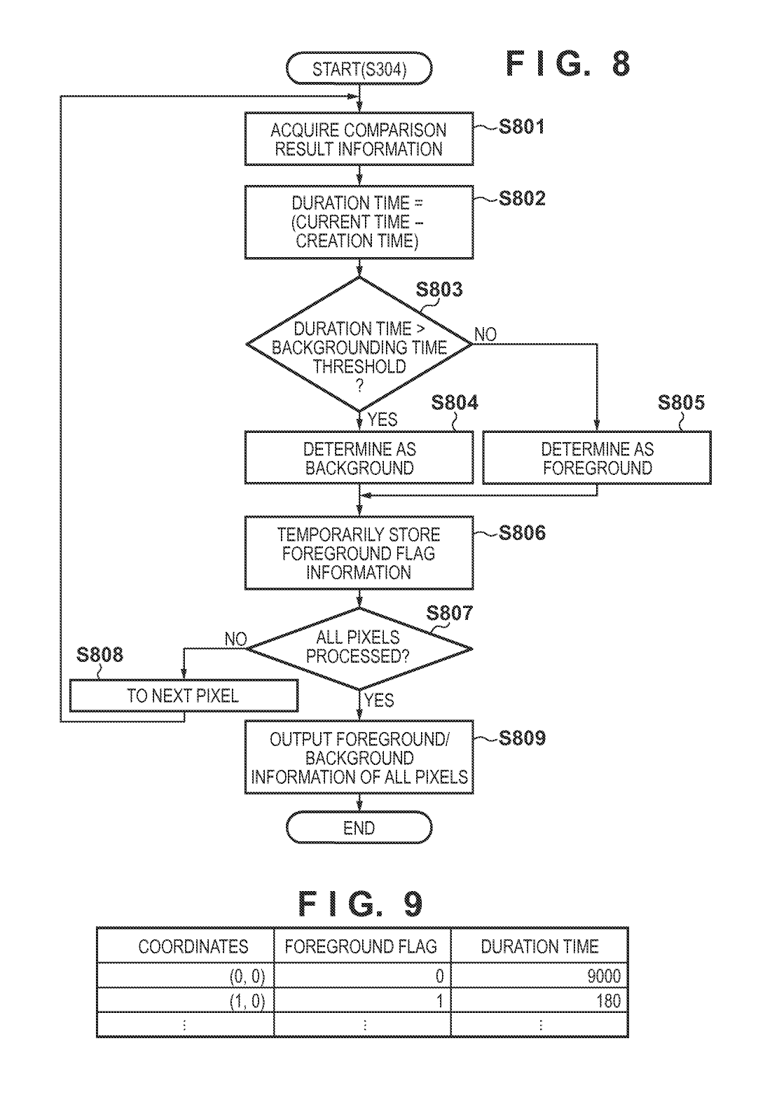

On the other hand, in step S809, the foreground/background determination unit 206 sends the set (FIG. 9) stored in step S806 for each pixel position to the scene change detection unit 207 and the object region output unit 209 as foreground/background information.

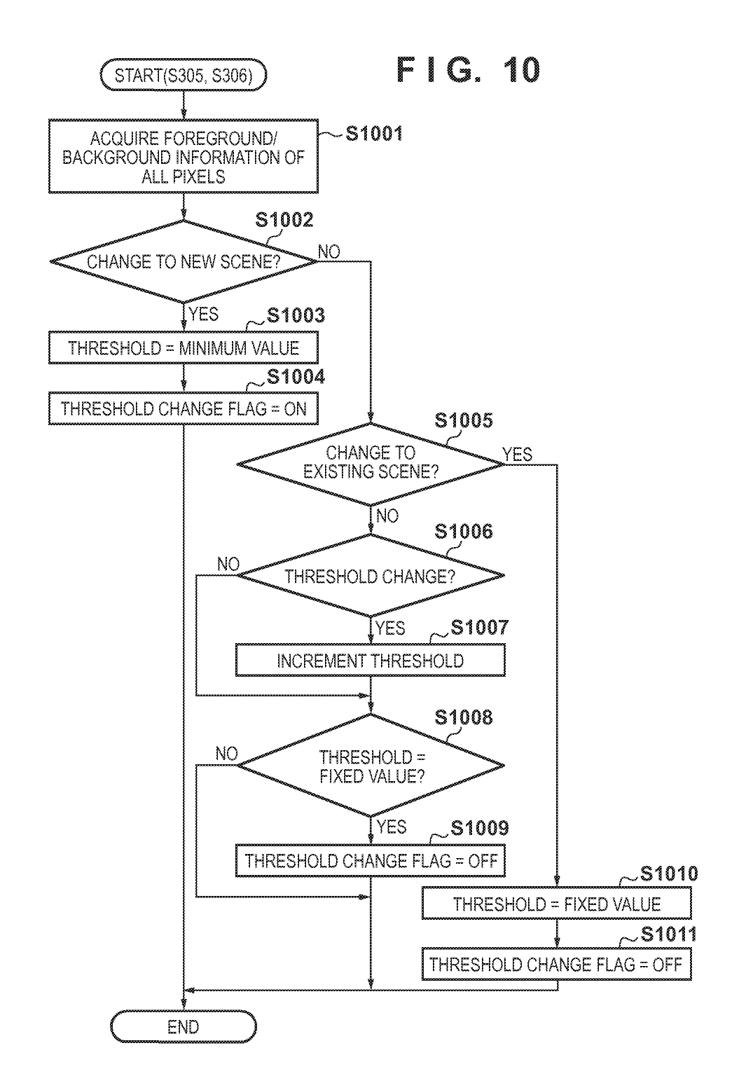

In step S305, the scene change detection unit 207 determines the presence/absence of a scene change using the foreground/background information of each pixel position received from the foreground/background determination unit 206. Upon determining that a scene change has occurred, the process advances to step S306. Upon determining that no scene change has occurred, the process advances to step S307. In step S306, the backgrounding time threshold changing unit 208 changes the threshold B. Details of processes in steps S305 and S306 will be described with reference to the flowchart of FIG. 10.

In step S1001, the scene change detection unit 207 acquires the foreground/background information of each pixel position sent from the foreground/background determination unit 206. In step S1002, the scene change detection unit 207 determines using the foreground/background information of each pixel position whether a scene change to a new scene has occurred. The new scene is a scene that has not been sensed hitherto, that is, a scene that is not stored in the background model. For example, if a scene with the illumination on has continued so far, the new scene corresponds to a scene with the illumination off. It also corresponds to a case in which the sensing direction of the camera changes to sense a place different from that till the present time.

The scene change is a short-time change in the video all over entire screen. For example, if a scene with the illumination on changes to a scene with the illumination off, the luminances of the pixels change from large values (states) to small values (states) all over the screen. In case of the scene change to a new scene, the new state is added to the background model in a short time. Hence, the following two methods are usable to determine the presence/absence of a scene change.

In the first method, the determination is done using the proportion of the foreground region in the frame image. When a scene change to a new scene has occurred, almost all pixels are newly added, and therefore, the duration time is short. For this reason, the foreground/background determination unit 206 determines almost all pixels as the foreground. Hence, in the first method, the value of the foreground flag is acquired from the foreground/background information of each pixel position. If the number of pixel positions for which (value of foreground flag=1) (the number of pixels determined as the foreground) is equal to or larger than a predetermined number (for example, the number corresponding to 70% of the number of pixels of the frame image f), it is determined that a scene change has occurred.

In the second method, the determination is done using the duration time included in the foreground/background information. As described above, the duration times of most pixels are very short in the scene change to a new scene. In the second method, the duration time is acquired for the foreground/background information of each pixel position. If the number of pixel positions for which (duration time<threshold (for example, 0.5 sec) (15 frames at 30 frames per sec)) is equal to or larger than a predetermined number (for example, the number corresponding to 70% of the number of pixels of the frame image f), it is determined that a scene change has occurred.

For example, in step S1002, the scene change detection unit 207 determines the presence/absence of a scene change using the first method. Upon determining that a scene change has occurred, the process advances to step S1003. Upon determining that no scene change has occurred, the process advances to step S1005. In step S1002, the presence/absence of a scene change may be determined in consideration of the determination result of the second method as well as the determination result of the first method.

In step S1003, the backgrounding time threshold changing unit 208 changes the threshold B to a preset minimum value the threshold B can take. This allows handling the region determined as the foreground (object) as the background.

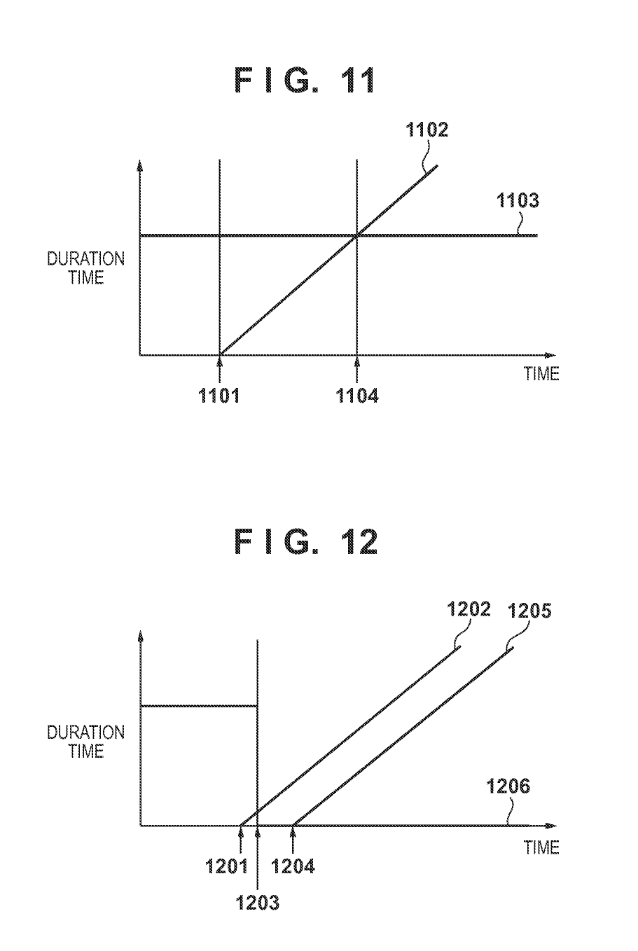

The relationship between the control of the threshold B and the foreground/background determination will be explained with reference to the graph of FIG. 11. Referring to FIG. 11, the abscissa represents the time (frame number is also usable), and the ordinate represents the duration time.

The duration time of each pixel included in an object that has appeared at a time 1101 increases along with the elapse of the time as long as the object is at a standstill. Hence, a change in the duration time of the pixel relative to the elapse of the time is represented by a line 1102 having a gradient of 1.

A horizontal line 1103 represents the backgrounding time threshold B. As described above, in step S803, a pixel having a duration time longer than the threshold B is determined as a pixel constituting the foreground. Hence, a pixel is determined as the background when it is located on the upper side of the line 1103 or as the foreground when located on the lower side. That is, the state represented by the line 1102 is determined as the foreground from the time 1101 to a time 1104 where the lines 1102 and 1103 cross each other.

FIG. 12 is a graph in which the abscissa represents the time, and the ordinate represents the duration time, like FIG. 11. A change in the duration time of a pixel in a change region caused by turning off the illumination at a time 1201 is represented by a line 1202. Assume that a scene change to a new scene is detected at a time 1203 (step S1002), and the backgrounding time threshold B is set to the minimum value (step S1003). With this processing, the line 1202 is always located on the upper side of the backgrounding time threshold B (1206) after the time 1203. That is, the duration time is longer than the backgrounding time threshold B. Hence, the state caused by turning off the illumination is determined as the background.

Note that since the changed backgrounding time threshold B is used in the next frame image, a detection error in the entire screen occurs in at least one frame. To avoid this, after determining the scene change to a new scene in step S1002 and changing the threshold B to the minimum value, the foreground/background determination processing (step S304) is repeated again.

In step S1004, the backgrounding time threshold changing unit 208 sets a threshold change flag to a value representing that the threshold B has been changed from the normal value (predetermined maximum value). In this embodiment, a value representing that the threshold B has been changed from the normal value is “ON”, and a value representing that the threshold B is the normal value is “OFF”.

In step S1005, the scene change detection unit 207 determines whether a scene change of an existing scene has occurred. Details of the processing in this step will be described later. Upon determining that a scene change to an existing scene has occurred, the process advances to step S1010. If no scene change to an existing scene has occurred, the process advances to step S1006. The processes in steps S1010 and S1011 will be described later.

In step S1006, the backgrounding time threshold changing unit 208 determines whether the value of the threshold change flag is “ON”. Upon determining that the value of the threshold change flag is “ON”, the process advances to step S1007. If the value of the threshold change flag is “OFF”, the process advances to step S1008.

In step S1007, the backgrounding time threshold changing unit 208 increments the threshold B by a predetermined amount. The increment amount can always be constant or change in accordance with a predetermined rule (for example, predetermined function).

In step S1008, the backgrounding time threshold changing unit 208 determines whether the threshold B has reached the above-described normal value (fixed value). Upon determining that the threshold B has reached the normal value, the process advances to step S1009. If the threshold B has not reached yet, the process advances to step S307. In step S1009, the backgrounding time threshold changing unit 208 sets the value of the threshold change flag to “OFF”.

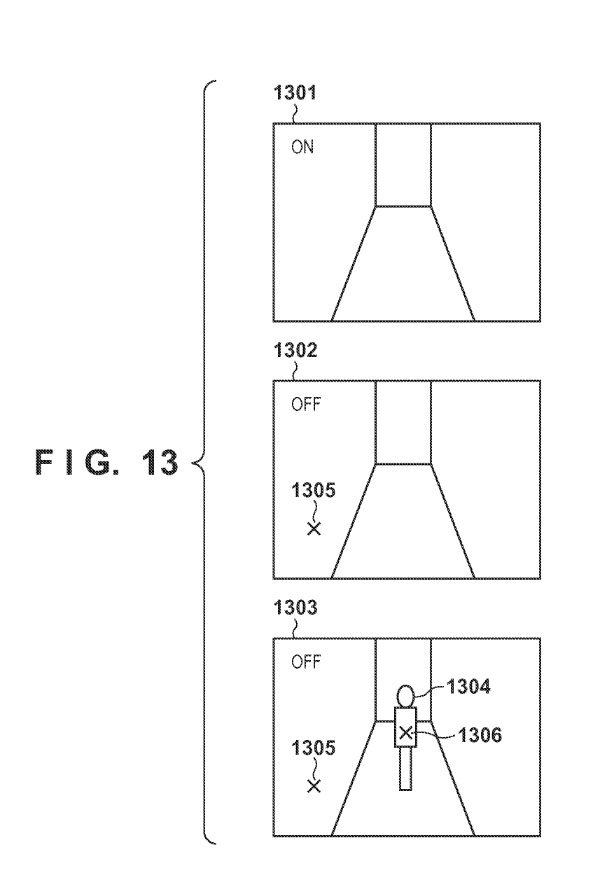

The reason for the series of processes will be described. For example, assume that frame images 1301, 1302, and 1303 shown in FIG. 13 are sequentially input. The image 1301 includes only a passage (only the background). Characters “ON” on the image 1301 are put for the sake of convenience to indicate that the illumination is on in the scene of the image 1301 but not included in the actual image 1301.

The image 1302 includes only the passage (only the background), like the image 1301. Characters “OFF” on the image 1302 are put for the sake of convenience to indicate that the illumination is off in the scene of the image 1302 but not included in the actual image 1302. This also applies to the image 1303. Note that even when the illumination is turned off, a brightness that allows a human to confirm the presence/absence of an object upon viewing the video is ensured by an emergency light or natural light from a window. In the image 1303, a person 1304 newly appears and stands still.

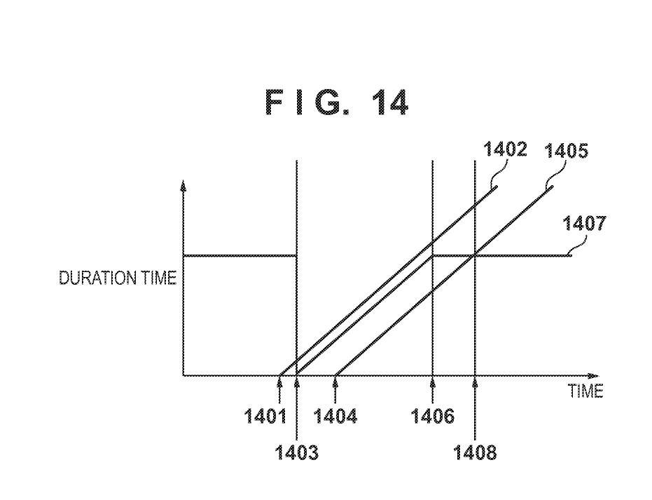

Threshold change processing performed when the images 1301 to 1303 are sequentially input will be described with reference to FIG. 14. FIG. 14 is a graph in which the abscissa represents the time, and the ordinate represents the duration time, like FIG. 11.

A time 1401 indicates the time (image 1302) at which the illumination is turned off (corresponding to the time 1201 in FIG. 12). The duration time of a pixel 1305 in a change region caused at this time is represented by a line 1402 (corresponding to the line 1202 in FIG. 12). At a time 1403, the backgrounding time threshold is set to the minimum value (corresponding to the time 1203 in FIG. 12). A time 1404 is a time at which the person 1304 appears, as in the image 1303 shown in FIG. 13 (corresponding to a time 1204 in FIG. 12). The duration time of a pixel 1306 included in the person is represented by a line 1405 (corresponding to a line 1205 in FIG. 12).

If the backgrounding time threshold remains the minimum value, as shown in FIG. 12 (line 1206), the line 1205 never comes to the lower side of the backgrounding time threshold. For this reason, the person 1304 is always handled as the background and cannot therefore be detected. To prevent this, the backgrounding time threshold is gradually returned to the normal value along with the elapse of the time so as to normally detect the object that has appeared after the scene change. That is, the backgrounding time threshold is set to a line 1407 having a gradient of 1 from the time 1403 to a time 1406.

The line 1405 representing the duration time of the pixel 1306 included in the person 1304 who has appeared at the time 1404 crosses the backgrounding time threshold having the normal value at a time 1408. Hence, the person 1304 is determined as the foreground from the time 1404 to the time 1408 (the time of the normal value because the gradient is 1). In this way, the stationary object can be detected as usual during the time of the normal value immediately after scene change detection (time 1403).

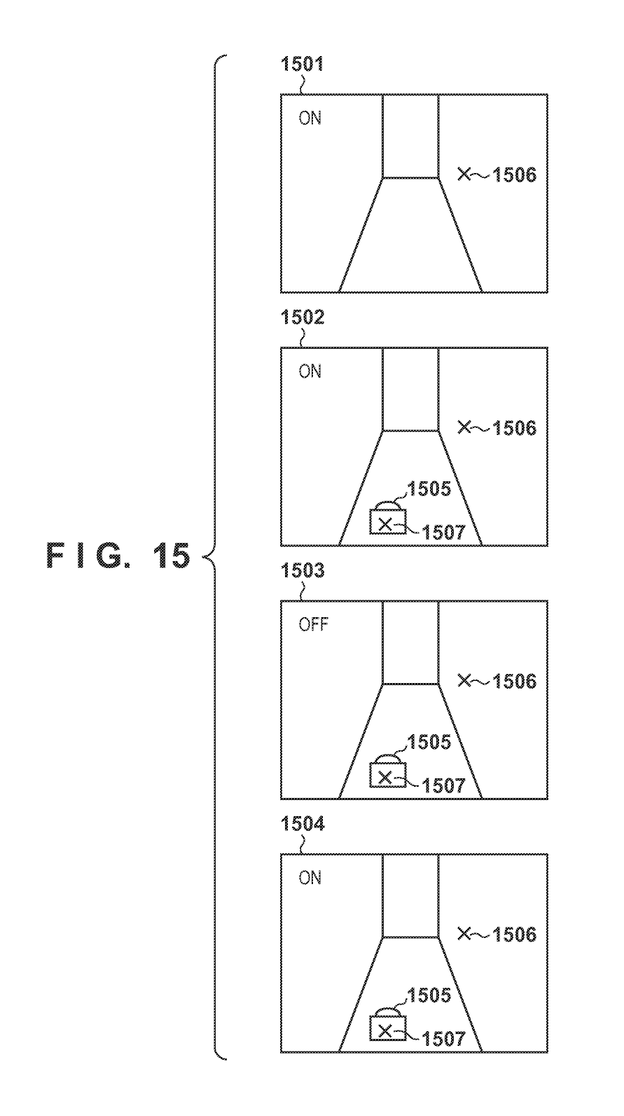

As described above, even in a case in which, for example, the illumination is turned off, temporary detection of the stationary object can be enabled immediately. However, if the illumination in the on state is temporarily turned off and then turned on again, the following problem arises. For example, assume that at the time of activation of the apparatus, only the passage (only the background) is included, and the illumination is on, as indicated by an image 1501 in FIG. 15. After a while, a bag 1505 is abandoned, as indicated by an image 1502. Then, the illumination is turned off for a predetermined time, as indicated by an image 1503, and then turned on again, as indicated by an image 1504. At this time, the bag 1505 remains abandoned.

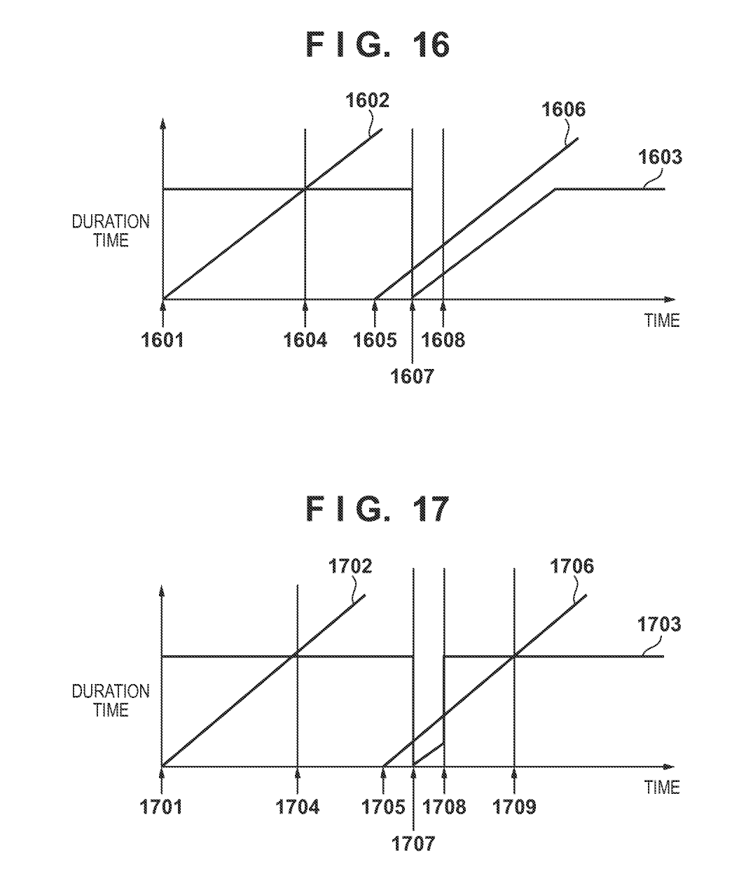

A change in the duration time at this time will be described with reference to the graph of FIG. 16. FIG. 16 is a graph in which the abscissa represents the time, and the ordinate represents the duration time, like FIG. 11.

A time 1601 is the time of activation of the apparatus (image 1501 in FIG. 15). The duration time of a pixel 1506 in the background is represented by a line 1602. A time 1604 at which the line 1602 crosses a backgrounding time threshold 1603 is the time at which the true background is determined as the background even in this processing apparatus (the time at which initialization is completed). A time 1605 is the time at which the bag appears (image 1502 in FIG. 15). The duration time of a pixel 1507 included in the bag is represented by a line 1606. A time 1607 corresponds to the time at which the illumination is turned off (image 1503 in FIG. 15). The backgrounding time threshold 1603 is temporarily decreased to the minimum value and then returned with a gradient of 1. A time 1608 is the time at which the illumination is turned on again (image 1504 in FIG. 15). Since the line 1606 is located on the upper side of the backgrounding time threshold 1603 after the time 1607, the bag that could be detected in the image 1502 is handled as the background. That is, continuous detection cannot be performed before and after the temporary illumination off section. The above-described problem can be solved by causing the scene change detection unit 207 to detect the return (scene change) to the existing scene (in this example, illumination on state).

The scene change to the existing scene is determined based on the number (proportion) of pixels determined as the background. The duration time (line 1602) of the pixel 1506 in the background in the illumination on state is always located on the upper side of the backgrounding time threshold 1603 after the time 1604, and the pixel 1506 therefore constitutes the background. After the time 1608 at which the illumination is turned on again, the state registered in the background model at the time 1601 (the feature amount in the illumination on state) becomes close to the input video again. Hence, the pixels in the background except the region of the bag 1505 exceed the normal value of the backgrounding time threshold. As described above, when a scene change to an existing scene occurs, the proportion of the background in the screen is high, and the proportion of pixels having long duration times becomes high. The total number of pixels having duration times longer than the normal value of the backgrounding time threshold is counted. The count value is divided by the total number of pixels to obtain the proportion. If the proportion is equal to or higher than, for example, 70%, it is determined that a scene change to the existing scene has occurred. Note that when a plurality of states (illumination on state and illumination off state) are stored in the background model, the duration time can correctly be obtained. This enables the determination.

In step S1005 described above, the scene change detection unit 207 acquires the value of the foreground flag from the foreground/background information of each pixel position. If the number of pixel positions for which (value of foreground flag=0) (the number of pixels determined as the background) is equal to or larger than a predetermined number (for example, the number corresponding to 70% of the number of pixels of the frame image f), it is determined that a scene change to an existing scene has occurred.

Upon determining that “a scene change to an existing scene has occurred”, the process advances to step S1010. On the other hand, upon determining that “no scene change to an existing scene has occurred”, the process advances to step S1006.

In step S1010, the backgrounding time threshold changing unit 208 sets the threshold B to the normal value. In step S1011, the backgrounding time threshold changing unit 208 sets the value of the threshold change flag to “OFF”.

The above-described series of steps will be described with reference to the example shown in FIG. 15. FIG. 17 is a graph in which the abscissa represents the time, and the ordinate represents the duration time, like FIG. 11. A time 1701 is the time of activation of the apparatus (corresponding to the time 1601 in FIG. 16). The duration time of the pixel 1506 in the background is represented by a line 1702 (corresponding to the line 1602 in FIG. 16). A time 1704 is the time at which initialization is completed (corresponding to the time 1604 in FIG. 16). A time 1705 is the time at which the bag appears (corresponding to the time 1605 in FIG. 16). The duration time of the pixel 1507 included in the bag 1505 is represented by a line 1706. A time 1707 corresponds to the time at which the illumination is turned off (time 1607 in FIG. 16). The backgrounding time threshold is temporarily decreased to the minimum value and then returned with a gradient of 1. A time 1708 corresponds to the time at which the illumination is turned on again (time 1608 in FIG. 16). The duration time (line 1702) of a background pixel like the pixel 1506 is always larger than the normal value of the backgrounding time threshold. Hence, the scene change to the existing scene is detected in step S1005, and the backgrounding time threshold is returned to the normal value in step S1010. The backgrounding time threshold thus changes as indicated by a polygonal line 1703. Since the line 1706 representing the duration time of the pixel 1507 included in the bag 1505 is located on the lower side of the backgrounding time threshold again in the section from the time 1708 to a time 1709, the pixel is determined as the foreground, as can be seen.

As described above, even if a new scene is temporarily obtained (by, for example, temporarily turning off the illumination), the stationary object can continuously be detected during a predetermined time.

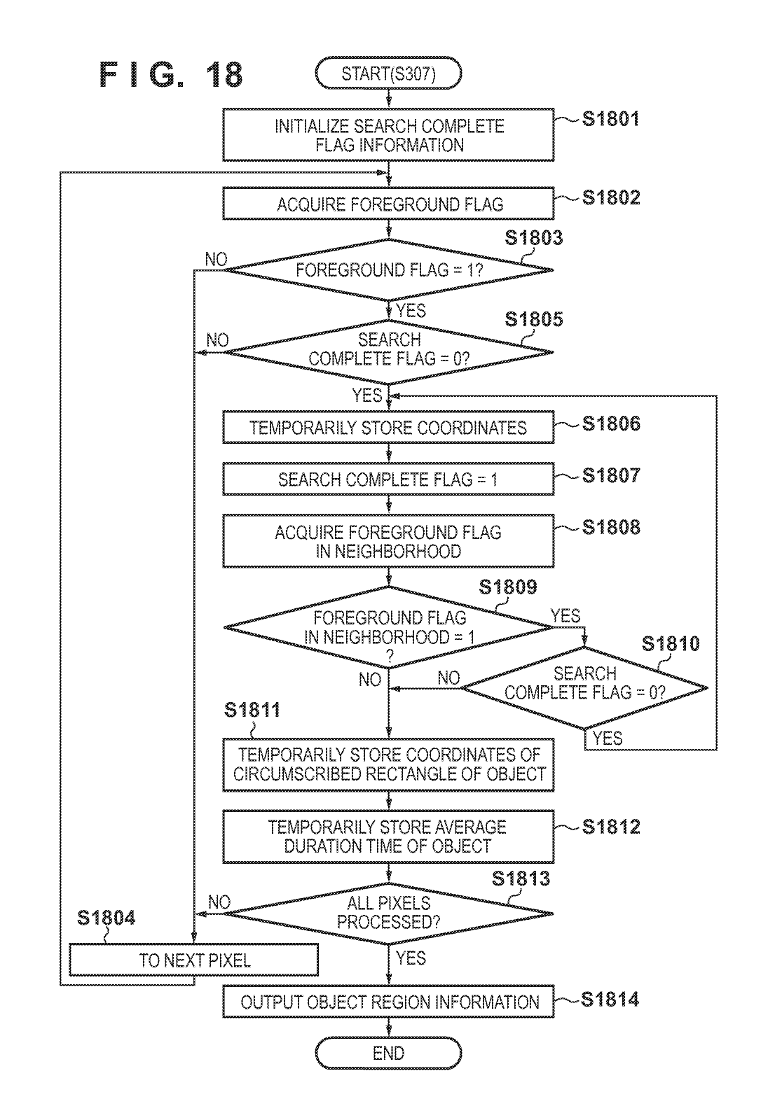

Details of processing in step S307 will be described next with reference to FIG. 18 illustrating the flowchart of the processing.

In step S1801, the object region output unit 209 initializes the value of a search complete flag for each pixel position in the frame image f to 0. The initialization value is not limited to 0, and it need only be discriminated from the value set in the search complete flag in step S1807 or the like to be described below.

In step S1802, the object region output unit 209 acquires “the value of the foreground flag of the pixel position (x, y)” stored in the memory in step S806 (0≦x≦(number of x-direction pixels of frame image f−1), 0≦y≦(number of y-direction pixels of frame image f−1). Note that when performing the processing in step S1802 for the first time, x=y=0.

In step S1803, the object region output unit 209 determines whether the value of the foreground flag acquired in step S1802 is 1. Upon determining that the value of the foreground flag acquired in step S1802 is 1, the process advances to step S1805. If the value of the foreground flag acquired in step S1802 is 0, the process advances to step S1804.

In step S1804, the object region output unit 209 moves the pixel position to be referred to by one and performs the processes from step S1802 for the pixel position after the movement.

On the other hand, in step S1805, the object region output unit 209 determines whether the value of the search complete flag of the pixel position (x, y) is 0. Upon determining that the value of the search complete flag of the pixel position (x, y) is 0, the process advances to step S1806. If the value of the search complete flag of the pixel position (x, y) is 1, the process advances to step S1804.

In step S1806, the object region output unit 209 stores the pixel position (x, y) in the appropriate memory of the image processing apparatus.

In step S1807, the object region output unit 209 sets the value of the search complete flag of the pixel position (x, y) to 1.

In step S1808, the object region output unit 209 selects one of pixel positions (for example, four or six pixel positions adjacent to the pixel position (x, y)) around the pixel position (x, y) as a selected pixel position, and acquires the value of the foreground flag of the selected pixel position.

In step S1809, the object region output unit 209 determines whether the value of the foreground flag acquired in step S1808 is 1. Upon determining that the value of the foreground flag acquired in step S1808 is 1, the process advances to step S1810. If the value of the foreground flag acquired in step S1808 is 0, the process advances to step S1811.

In step S1810, the object region output unit 209 determines whether the value of the search complete flag of the selected pixel position is 0. Upon determining that the value is 0, the process advances to step S1806. If the value is not 0, the process advances to step S1811.

When the process advances from step S1810 to step S1806, in step S1806, the selected pixel position is stored in the appropriate memory of the image processing apparatus. In step S1807, the value of the search complete flag of the selected pixel position is set to 1. In step S1808, an unselected neighbor pixel position is selected from the above-described neighbor pixel positions as the selected pixel position, and the subsequent processing is continued.

In step S1811, the object region output unit 209 refers to each pixel position stored in the memory in step S1806, and obtains a rectangle region including all the pixel positions on the frame image f. For example, the maximum value/minimum value of the x-coordinate and the maximum value/minimum value of the y-coordinate are specified out of the pixel positions stored in the memory in step S1806. A rectangle region having the coordinate position (minimum value of x-coordinate, minimum value of y-coordinate) at the upper left corner and the coordinate position (maximum value of x-coordinate, maximum value of y-coordinate) at the lower right corner is obtained. This rectangle region is the region of the circumscribed rectangle of the region including the object in the frame image f. In step S1811, region information representing the rectangle region is stored in the appropriate memory of the image processing apparatus. Various formats can be applied to the format of the rectangle region. For example, a set of the coordinate position of the upper left corner and the coordinate position of the lower right corner may be stored in the memory as the region information.

In step S1812, the object region output unit 209 acquires “the duration time of pixel position” stored in the memory in step S806 for each pixel position stored in the memory in step S1806. The average value of the duration times of the respective pixel positions stored in the memory in step S806 is obtained as an average duration time. The obtained average duration time is stored in the appropriate memory of the image processing apparatus.

In step S1813, the object region output unit 209 determines whether the processes of steps S1801 to S1812 have been done for all pixel positions included in the frame image f. Upon determining that the processes of steps S1801 to S1812 have been done for all pixel positions included in the frame image f, the process advances to step S1814. If, out of all pixel positions included in the frame image f, a pixel position that has not undergone the processes of steps S1801 to S1812 yet remains, the process advances to step S1804.

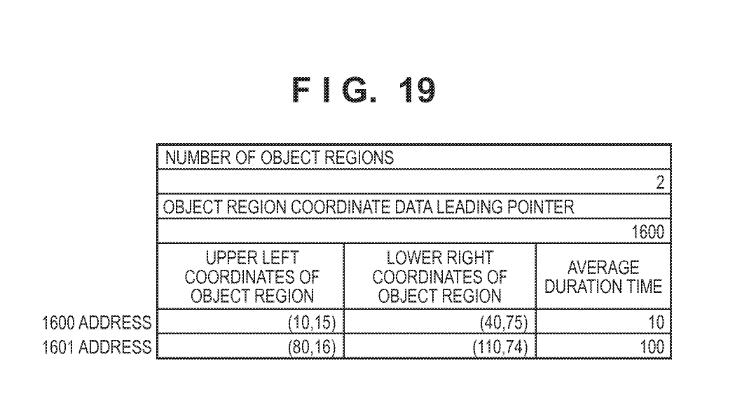

In step S1814, the object region output unit 209 counts the number of region information stored in the appropriate memory of the image processing apparatus, for example, the number of sets of upper left coordinate positions and lower right coordinate positions. The object region output unit 209 outputs the counted number, each region information, and each average duration time as object region information. The structure of the object region information is not limited to a specific structure. FIG. 19 shows an example of the structure of the object region information.

In the object region information having the structure shown in FIG. 19, the number of region information is registered. In addition, a set of region information (upper left coordinate position and lower right coordinate position) and an average duration time obtained from a region represented by the region information is registered for each region information. The start registration address out of the registration addresses of each set is also registered as an object region coordinate data leading pointer.

The output destination and use method of the output object region information are not particularly mentioned in this embodiment. For example, the object region information may be used in an abandoned object detection apparatus for detecting occurrence of an abandoned object. The abandoned object detection apparatus refers to the average duration time of an object. When the average duration time has exceeded a predetermined time, an alarm about the abandonment event is issued. In addition, the position of the abandoned object may be displayed for the user by synthesizing the frame of the region represented by region information with the frame image.

<Modification of First Embodiment>

When sending object region information not to an abandoned object detection apparatus but to a camera tampering detection apparatus, a condition for the scene change detection unit 207 to determine a scene change may be added.

In camera tampering detection, tampering to disturb normal sensing by, for example, putting a cloth on the camera or irradiating the camera with light is detected. In camera tampering detection, when the proportion of the total area of an object region in the screen is high, it is determined that tampering has occurred. However, if the apparatus reacts to a phenomenon like flickering of a fluorescent light, a false alarm is issued many times. To prevent this, when the proportion of the total area of an object region in the screen is high continuously for a predetermined time, it is determined that tampering has occurred.

In the above-described arrangement, the backgrounding time threshold is immediately initialized upon detecting a scene change to a new scene. For this reason, the result of the object region that accounts for a large proportion cannot be output for a predetermined time. Hence, to enable camera tampering detection, a condition that “frames in which the foreground region accounts for a large proportion of the frame image continue for a predetermined time” is added to the condition to determine a scene change to a new scene. This allows outputting a large detection error region for the predetermined time. Hence, a tampering can normally be detected by the camera tampering detection. As for the addition of the condition, the condition may be added when, for example, the user has input an instruction to “perform camera tampering detection” by operating an operation unit (not shown).

Instead of causing the scene change detection unit 207 to detect a scene change to a new scene, the camera tampering detection apparatus may perform the detection. For this purpose, to enable the camera tampering detection apparatus to notify the image processing apparatus of detected tampering, the image processing apparatus and the camera tampering detection apparatus need to be communicably connected. The camera tampering detection apparatus may be provided as a module that operates in the image processing apparatus so as to perform communication in the image processing apparatus, as a matter of course.

In this case, the scene change detection unit 207 confirms in step S1002 whether a notification representing that a tampering has been detected has been received from the camera tampering detection apparatus, instead of performing determination using the foreground/background information. Upon receiving the notification representing that a tampering has been detected, the steps from step S1003 are executed. If no notification has been received, the steps from step S1005 are executed.

The units shown in FIG. 2 can be formed as constituent elements in one image processing apparatus or distributed to several apparatuses. In this case, the several apparatuses are connected so as to be communicable with each other and perform the above-described processing while performing communication with each other. The units shown in FIG. 2 may be placed in an integrated circuit chip and integrated with, for example, a data input unit provided in a PC (Personal Computer).

<General Arrangement of First Embodiment>

In the first embodiment, the operation of the image processing apparatus has been described while defining the rectangle region as a region of each pixel and the image feature amount as a pixel value for the sake of simplicity. However, this operation is merely an example of an operation to be described below.

First, the image processing apparatus inputs the image of each frame as a frame image, and acquires the image feature amount of each rectangle region included in the input frame image. For each rectangle region included in the frame image of interest, a registered image feature amount most similar to the image feature amount of the rectangle region is specified out of registered image feature amounts registered in a first table.

For each rectangle region included in the frame image of interest, it is determined whether the similarity between the registered image feature amount specified for the rectangle region and the image feature amount of the rectangle region is equal to or higher than a threshold. An example of the similarity is the above-described “difference”.

For a rectangle region determined to have a similarity equal to or higher than the threshold out of the rectangle regions included in the frame image of interest, the following processing is performed. That is, a set of the registered image feature amount specified for the rectangle region and the timing at which the registered image feature amount was registered in the first table is registered in a second table. In addition, the registered image feature amount in the first table is updated using the image feature amount of the rectangle region.

On the other hand, for a rectangle region determined to have a similarity lower than the threshold out of the rectangle regions included in the frame image of interest, the following processing is performed. That is, a set of the image feature amount of the rectangle region and the timing at which the image feature amount was registered in the second table is registered in the second table. In addition, the image feature amount is registered in the first table as the registered image feature amount for the rectangle region.

Next, for each rectangle region included in the frame image of interest, the period length from the timing at which the registration in the second table was done for the rectangle region to the current timing is obtained. Out of the rectangle regions included in the frame image of interest, a rectangle region having a period length equal to or less than a period length threshold is defined as a foreground rectangle region, and a rectangle region having a period length more than the period length threshold is defined as a background rectangle region. At this time, if the number of rectangle regions determined as a foreground rectangle region out of the rectangle regions included in the frame image of interest is equal to or larger than a predetermined number, it is determined that a scene change has occurred. If the number of rectangle regions is smaller than the predetermined number, it is determined that no scene change has occurred.

Upon determining that a scene change has occurred, the period length threshold is set to a predetermined minimum value. Region information representing the region of the object included in the foreground rectangle region and an average period length of the period lengths obtained for the foreground rectangle region are output.

### Second Embodiment

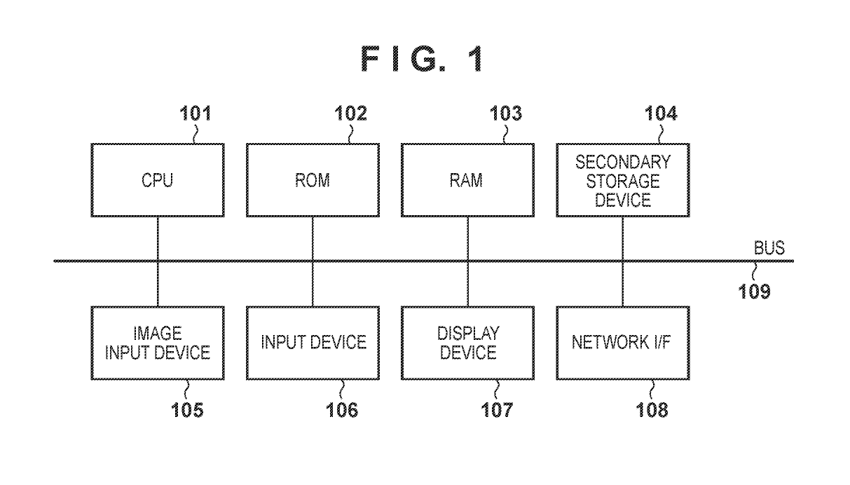

The units shown in FIG. 2 may be formed by hardware. However, for example, a background model storage unit 204 may be formed using a memory such as a RAM or a hard disk, a video input unit 201 may be formed using a video input interface, and the remaining units may be formed using software (computer program). In this case, when the software is installed in a computer including the memory and the video input interface and also including a processor capable of executing the software, the processor can be caused to execute the software. Since this allows the computer to implement the functions of the units shown in FIG. 2, the computer can be applied to the above-described image processing apparatus. FIG. 1 illustrates an example of the arrangement of a computer applicable to the above-described image processing apparatus.

A CPU 101 executes processing using computer programs and data stored in a ROM 102 and a RAM 103, thereby controlling the operation of the whole computer and also executing each process described as a process to be executed by the above-described image processing apparatus.

The ROM 102 stores the setting data and boot program of the computer.

The RAM 103 has an area to temporarily store computer programs and data loaded from a secondary storage device 104 and the frame image of each frame input by an image input device 105. The RAM 103 also has an area to temporarily store data received from an external apparatus via a network I/F 108 and a work area used by the CPU 101 to execute various kinds of processing. That is, the RAM 103 can provide various kinds of areas as needed.

The secondary storage device 104 is a mass information storage device represented by a hard disk drive. The secondary storage device 104 stores an OS (Operating System), and computer programs and data used to cause the CPU 101 to execute the functions of the units except the video input unit 201 and the background model storage unit 204 in FIG. 2. The secondary storage device 104 also functions as the background model storage unit 204. The computer programs and data stored in the secondary storage device 104 are loaded to the RAM 103 as needed under the control of the CPU 101 and processed by the CPU 101.

The image input device 105 is an apparatus for inputting the frame image of each frame and corresponds to the video input unit 201 in FIG. 2. As described above, the units shown in FIG. 2 may be placed in an integrated circuit chip and integrated with the image input device 105.

An input device 106 is formed from a keyboard, a mouse, and the like. The user of the computer can input various instructions to the CPU 101 by operating the input device 106. For example, the above-described instruction to “perform camera tampering detection” may be input using the input device 106.

A display device 107 is formed from a CRT or a liquid crystal panel and can display a processing result of the CPU 101 by an image, characters, and the like. For example, the above-described object region information or an indication based on the object region information may be displayed on the screen of the display device 107.

The network I/F 108 is an interface used to perform data communication with an external apparatus via a network such as a LAN or the Internet. For example, the object region information may be transmitted to the external apparatus via the network I/F 108.

The above-described units are connected to a bus 109. Note that the arrangement shown in FIG. 1 is merely an example. Another arrangement may be added to the arrangement depending on the operation purpose, or structural elements that are unnecessary depending on the purpose may be omitted.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-090449, filed Apr. 11, 2012, which is hereby incorporated by reference herein in its entirety.

What is claimed is:

1. A video processing apparatus comprising:
a comparison unit configured to compare an input video with a background model;
a timer unit configured to measure, based on a comparison result of said comparison unit, a duration time during which a difference region different from the background model continues in the input video;
a determination unit configured to determine the difference region whose duration time is less than a predetermined threshold as a foreground;
a detection unit configured to detect a scene change in the input video based on the comparison result of said comparison unit; and
a changing unit configured to change the predetermined threshold when said detection unit has detected the scene change.

2. The apparatus according to claim 1, wherein the background model represents a feature amount of a background image, and
said comparison unit extracts the feature amount from the input video and compares the extracted feature amount with the background model.

3. The apparatus according to claim 2, further comprising a storage unit configured to store the feature amount and an appearance time at which the feature amount has newly appeared,
wherein said timer unit measures the duration time during from the appearance time stored in said storage unit.

4. The apparatus according to claim 1, wherein said changing unit changes the predetermined threshold to a value smaller than a current value when said detection unit has detected the scene change.

5. The apparatus according to claim 4, wherein said changing unit changes the predetermined threshold to the value smaller than the current value and then gradually increases the predetermined threshold.

6. The apparatus according to claim 2, wherein the background model represents the feature amount of each partial region of the background image,
said comparison unit extracts the feature amount for each partial region of the input video and compares the extracted feature amount with the background model,
said timer unit measures the duration time for each partial region, and
said determination unit determines for each partial region whether the partial region belongs to the foreground.

7. The apparatus according to claim 1, wherein said changing unit changes the predetermined threshold to a value before change when said detection unit has detected a change to a scene having a feature amount similar to a feature amount in the background model.

8. The apparatus according to claim 6, wherein said detection unit detects the scene change based on a proportion of partial regions having a duration time satisfying a predetermined condition to an entire image.

9. A video processing method comprising:
a comparison step of comparing an input video with a background model;
a timer step of measuring, based on a comparison result in the comparison step, a duration time during which a difference region different from the background model continues in the input video;
a determination step of determining the difference region whose duration time is less than a predetermined threshold as a foreground;
a detection step of detecting a scene change in the input video based on the comparison result in the comparison step; and
a changing step of changing the predetermined threshold when the scene change has been detected in the detection step.

10. A non-transitory computer-readable storage medium storing a computer program for causing a computer to function as each unit of a video processing apparatus of claim 1.
